(19) United States
(12) Patent Application Publication
(10) Pub. No.: US 2011/0311764 A1
(43) Pub. Date: Dec. 22, 2011

(54) MULTI-SCALE, MULTI-FUNCTIONAL MICROSTRUCTURED MATERIAL

(75) Inventors: Ralph A. Hulseman, Greenville, SC (US); Andrew Cannon, Anderson, SC (US); Robert E. Mammarella, Greer, SC (US); William P. King, Champaign, IL (US); David Mammarella, Greenville, SC (US)

(73) Assignee: HOOWAKI, LLC, Pendleton, SC (US)

(21) Appl. No.: 13/157,490

(22) Filed: Jun. 10, 2011

Related U.S. Application Data
(60) Provisional application No. 61/353,467, filed on Jun. 10, 2010.

(30) Foreign Application Priority Data
May 8, 2009 (US) PCT/US2009/043307
Jul. 2, 2009 (US) PCT/US2009/049565

(51) Int. Cl. B32B 3/00; B29C 43/00; B29C 39/00; B32B 3/24; B29C 33/40

(52) U.S. Cl. 428/131; 428/141; 264/219

(57) ABSTRACT

A microstructure disposed on a surface carried by an object comprising: a first set of microfeatures carried by the object wherein said first set of microfeatures causes the surface of the object to exhibit physical properties differing from physical properties exhibited by a non-microstructured surface; and, a second set of microfeatures carried by said surface wherein said second set of microfeatures causes the surface of the object to exhibit physical properties differing from physical properties exhibited by the non-microstructured surface and by said first set of microfeatures.

### CROSS-REFERENCE TO RELATED APPLICATION

This application claims the benefit of and the priority from: provisional patent application Ser. No. 61/353,467 entitled Multi-Scale, Multi-Functional Microstructured Material and patent application Ser. No. 12/869,603 entitled Method of Manufacturing Products Having A Metal Surface, which in turn claims priority from patent applications 61/237,119 and Ser. No. 12/813,833, which in turn claims priority from patent applications PCT/US09/043,307 and PCT/US09/049,565, all of which are incorporated by reference.

### BACKGROUND OF THE INVENTION

While microstructured surfaces have been proven useful for altering properties including hydrophobicity, hydrophilicity, friction, feel, appearance, and electrical properties, the use of microstructured surfaces to combine enhanced properties on a surface has not been demonstrated. Typically, microstructures cause the surface in which they are applied to exhibit only physical properties associated with that particular microstructure. For example, microstructures which result in superhydrophobicity (the extreme water repelling ability of some natural surfaces such as the lotus leaf and synthetic surfaces that mimic natural surface structures) do not readily prevent fluids from being pressed into the microstructure thereby degrading the microstructures effect.

Even though superhydrophobic microstructures have been a popular area of research since the late 1990's, these surfaces have low pressure resistance. Therefore, mechanical pressing of droplets into the surface easily pushes the droplets into the microstructures which cause the droplets to become “stuck” due to contact line pinning. “Stuck” droplets cannot take advantage of the superhydrophobic properties of the underlying surface and the advantages of the superhydrophobic surface can be lost.

Larger microstructures, however, can physically block an intruding item that would otherwise press liquid into the smaller superhydrophobic structures preventing droplets from becoming “stuck”. However, such larger microstructures do not exhibit the desirable superhydrophobic properties of the smaller structures.

Therefore, it is an object of the present invention to provide a microstructure that included an arrangement of various microfeatures such as a smaller set to provide or modify physical properties of the surface such as causing superhydrophobic effects and larger microfeatures to block intruding items.

It is another object of the present invention to provide a microstructure that includes multiple set of microfeatures each exhibiting different physical properties when integrated onto a surface of an object.

### SUMMARY OF THE INVENTION

The objects of the invention are achieved by providing a microstructure disposed on a surface carried by an object comprising: a first set of microfeatures carried by the object wherein the first set of microfeatures cause the surface of the object to exhibit properties selected from the group of: reduced friction, increased friction, increased heat transference, decreased condensation, increased condensation, liquid repellency, increased absorbance, increased capacitance, increase surface fluid storage, reduced boiling points of a substance in contact with the surface, increased boiling points of a substance in contact with the surface, reduced fluid drag, increased fluid drag, reduced sliding force, increased sliding force, reduced sliding force with applied lubrication, hydrophobic properties, hydrophilic properties, electrical properties, self-cleaning, reduction in hydrodynamic drag, reduction in aerodynamic drag, optical effects, prismatic effects, direction color effects, tactile effects, and any combination of these; and, a second stet of microfeatures carried by the surface wherein the second set of microfeatures is load bearing.

The invention can also include a method for manufacturing a microstructured manufacturing object comprising the steps of: fabricating a microstructured prototype having a first set of microfeatures that cause the surface of the object to have properties selected from a group of: reduced friction, increased friction, increased heat transference, decreased condensation, increased condensation, liquid repellency, increased absorbance, increased capacitance, increased surface fluid storage, reduced boiling points of a substance in contact with the surface, increased boiling points of a substance in contact with the surface, reduced fluid drag, increased fluid drag, reduced sliding force, increased sliding force, reduced sliding force with applied lubrication, hydrophobic properties, hydrophilic properties, electrical properties, self-cleaning, reduction in hydrodynamic drag, reduction in aerodynamic drag, optical effects, prismatic effects, direction color effects, tactile effects, and any combination of these, and, a second set of microfeatures carried by the surface wherein the second set of microfeatures is load bearing; creating a microstructured intermediate from the microstructured prototype so that the surface of the intermediate is a negative of the surface of the microstructured prototype; and, creating the microstructured manufacturing object from the microstructured intermediate.

The invention can also include a microstructure disposed on a surface carried by an object comprising: a first set of microfeatures carried by the object wherein the first set of microfeatures causes the surface of the object to exhibit physical properties differing from physical properties exhibited by a non-microstructured surface; and, a second set of microfeatures carried by the surface wherein the second set of microfeatures causes the surface of the object to exhibit physical properties differing from physical properties exhibited by the non-microstructured surface and by the first set of microfeatures.

In one embodiment, the microstructure can have a first set of microfeatures that has dimensions between 10 nm and 500 μm and said second set of microfeatures has dimensions between 10 nm and 500 μm. In one embodiment, the microstructure can have a first set of microfeatures that has dimensions between 10 nm and 1 μm and said second set of microfeatures has dimensions between 1 μm and 500 μm. In one embodiment, the dimensions of the first set of microfeatures is at least an order or magnitude smaller than that of the second set of microfeatures.

The height:width ratio of the first set of microfeatures is between 1:20 and 7:1. The microstructure can have a first set of microfeatures that have dimensions between 10 nm and 100 μm and the second set of microfeatures has dimensions 100 μm and larger. The spacing between the individual microfeatures can be variable.

### DESCRIPTION OF THE DRAWINGS

The following specification is further understood in reference to the following drawings:

FIG. 1, drawings of components of the invention;

FIG. 2, drawings of components of the invention;

FIG. 3, drawings of components of the invention;

FIG. 4, drawings of components of the invention;

FIG. 5, drawings of components of the invention;

FIG. 6, perspective image of the invention;

FIG. 7, image of the result of the invention;

FIG. 8, table illustrating the benefits of the structure of the invention;

FIG. 9, image of the invention; and,

FIG. 10 is a schematic of the invention.

### DESCRIPTION OF THE INVENTION

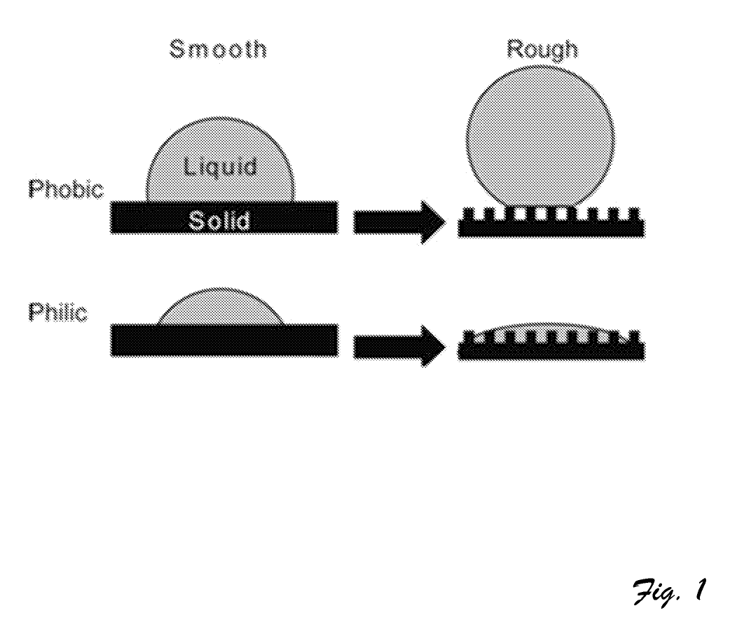

As FIG. 1 illustrates, simple surface roughening techniques can increase the surface area of a solid and thereby amplify the natural surface chemistry: phobic interactions become more phobic upon simple roughening, and philic interactions become more philic. When the surface is phobic to a liquid such as water, it is termed hydrophobic and can be rendered superhydrophobic by microstructuring. Surface roughness amplifies natural surface chemistry.

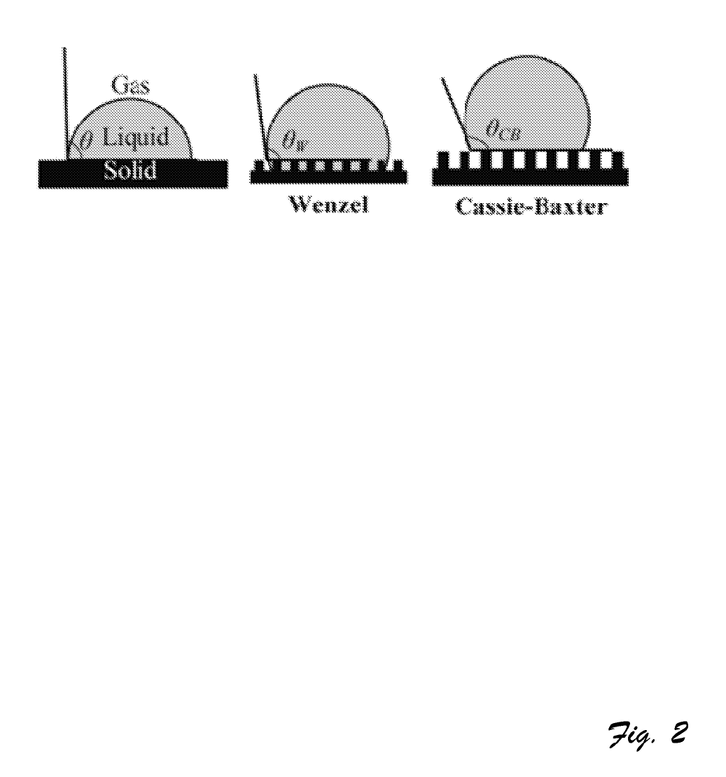

Three commonly used models describe different wetting states of a liquid drop resting on a solid: the Young relation, Wenzel relation, and Cassie-Baxter relation. In 1805, Thomas Young analyzed the interaction of a fluid droplet resting on a solid surface surrounded by a gas in FIG. 2 by performing a force balance of the interfacial forces. A droplet resting on a solid surface and surrounded by a gas forms a characteristic contact angle θ.

The force balance showed

$$cos θ = \frac{{γ}_{SV} - {γ}_{SL}}{{γ}_{LV}} \qquad ( 1 )$$

where the contact angle of the droplet θ is shown on the left hand side of FIG. 2, γ_{SV} is the interfacial tension between the solid and vapor, γ_{SL} is the interfacial tension between the solid and liquid, and γ_{LV} is the interfacial tension between the liquid and vapor. If γ_{SL}<γ_{SV}, the contact angle is less than 90°, and if the liquid is water then the solid is termed hydrophilic. If γ_{SL}>γ_{SV}, the contact angle is greater than 90°, and if the liquid is water then the solid is termed hydrophobic.

If the solid surface is rough, and the liquid is in intimate contact with the solid asperities, the droplet is in the Wenzel state. If the liquid rests on the tops of the asperities, it is in the Cassie-Baxter state.

In 1936, Wenzel examined roughened surfaces and assumed that liquid was in intimate contact with solid asperities. Wenzel determined that when the liquid moves a differential distance dx the liquid experiences a change of surface energy dE=r(γ_{SL}=γ_{SV})dx+γ_{LV}dx cos θ where r is the ratio of the actual area to the projected area. Because equilibrium implies dE/dx=0, the increased solid area interacting with the liquid will change θ to θ_{W} as

cos θ_{W}=r cos θ (2).

If we assume that the liquid is suspended on the tops of the asperities and denote φ to be the area fraction of the solid that the liquid touches, such a liquid that moves a differential distance dx experiences a change of surface energy dE=φ(γ_{SL}−γ_{SV})dx+(1−φ)γ_{LV}dx+γ_{LV}dx cos θ_{CB}. At equilibrium we can solve for the Cassie-Baxter equation:

cos θ_{CB}=φ(cos θ+1)−1 (3).

Liquid in the Cassie-Baxter state is more mobile than in the Wenzel state, and so the Cassie-Baxter state is often the desired state for superhydrophobic applications. We can predict whether the Wenzel or Cassie-Baxter state should exist by calculating the new contact angle with both equations. By a minimization of free energy argument, the relation that predicts the smaller new contact angle is the state most likely to exist. Stated mathematically, for the Cassie-Baxter state to exist, the following inequality must be true:

$$cos θ < \frac{ϕ - 1}{r - ϕ} . \qquad ( 4 )$$

To understand the interplay of surface chemistry and the geometric parameters involved in achieving the Cassie-Baxter state on flat microstructured surfaces, we used equation 4 to predict the pillar heights that cause a transition between the Wenzel and Cassie-Baxter states for a given original contact angle, microstructure diameter, pitch, and height.

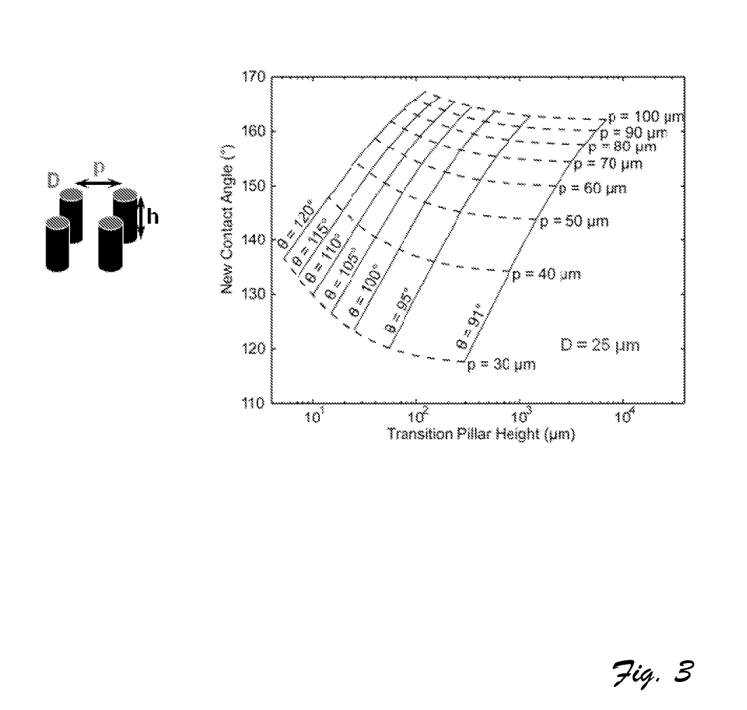

FIG. 3 shows the critical height versus new contact angle trends for a square lattice of circular micropillars with diameter of 25 μm, a pitch range from 30 μm to 100 μm, and contact angle range from 91° to 120°. 120° is generally accepted as the largest original contact angle currently possible, and critical pillar height is undefined for 90°. An example of how to use FIG. 3 follows: for materials with an original contact angle of 110°, to achieve θ_{CB} of 150°, a pitch of 50 μm is necessary. The microstructure height will also need to be large enough to cause the Cassie-Baxter state rather than the Wenzel state. FIG. 3 shows that for an original contact angle of 110° and pitch of 50 μm, a height of at least ˜45 μm is necessary to cause the Cassie-Baxter state. FIG. 3 also shows that increasing original contact angle reduces critical height and increases new contact angle. While it is possible to increase pitch and elicit higher new contact angles, the higher new contact angles come at a cost of increasingly high required microstructure height for the Cassie-Baxter state.

FIG. 3 shows the transition heights between Wenzel and Cassie-Baxter states vs new contact angle. In this Figures, the diameter=25 μm, pitch range=30-100 μm and the original contact angle range=91° to 120°.

When increasing the microstructure pitch, the pillars can be made tall enough to cause the Cassie-Baxter state. As θ increases, the critical height decreases for the same original pitch, and the new contact angle increases.

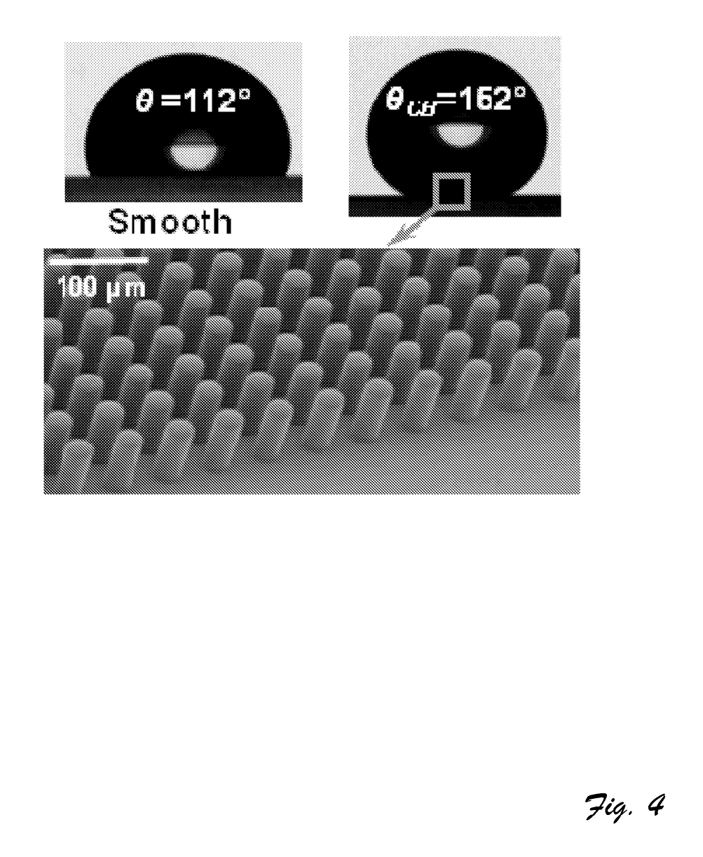

FIG. 4 shows fabricated single-scale superhydrophobic microstructures in silicone rubber. On smooth silicone the original contact angle=112°. When the silicone was structured with micropillars with diameter=25 μm, spacing=25 μm, and height=70 μm the new contact angle=152°. On smooth silicone the original contact angle=112°. When the silicone was structured with micropillars with diameter=25 μm, spacing=25 μm, and height=70 μm the new contact angle=152°.

Contact angle is a measure of static hydrophobicity, and contact angle hysteresis and slide angle are dynamic measures. Contact angle hysteresis is a phenomenon that characterizes surface heterogeneity. When a pipette injects a liquid onto a solid, the liquid will form some contact angle and three phase contact line. The three phase contact line is the line around the droplet where the three phases of solid, liquid, and vapor interact. As the pipette injects more liquid, the droplet will increase in volume, the contact angle will increase, but its three phase boundary will remain stationary until it suddenly advances outward. The contact angle the droplet had immediately before advancing outward is termed the advancing contact angle. The receding contact angle is now measured by pumping the liquid back out of the droplet. The droplet will decrease in volume, the contact angle will decrease, but its three phase boundary will remain stationary until it suddenly recedes inward. The contact angle the droplet had immediately before receding inward is termed the receding contact angle. The difference between advancing and receding contact angles is termed contact angle hysteresis which can be used to characterize surface heterogeneity, roughness, and mobility. Surfaces that are not chemically homogeneous will have domains which impede motion of the contact line. The slide angle is another dynamic measure of hydrophobicity and is measured by depositing a droplet on a surface and tilting the surface until the droplet begins to slide. Liquids in the Cassie-Baxter state generally exhibit lower slide angles and contact angle hysteresis than those in the Wenzel state.

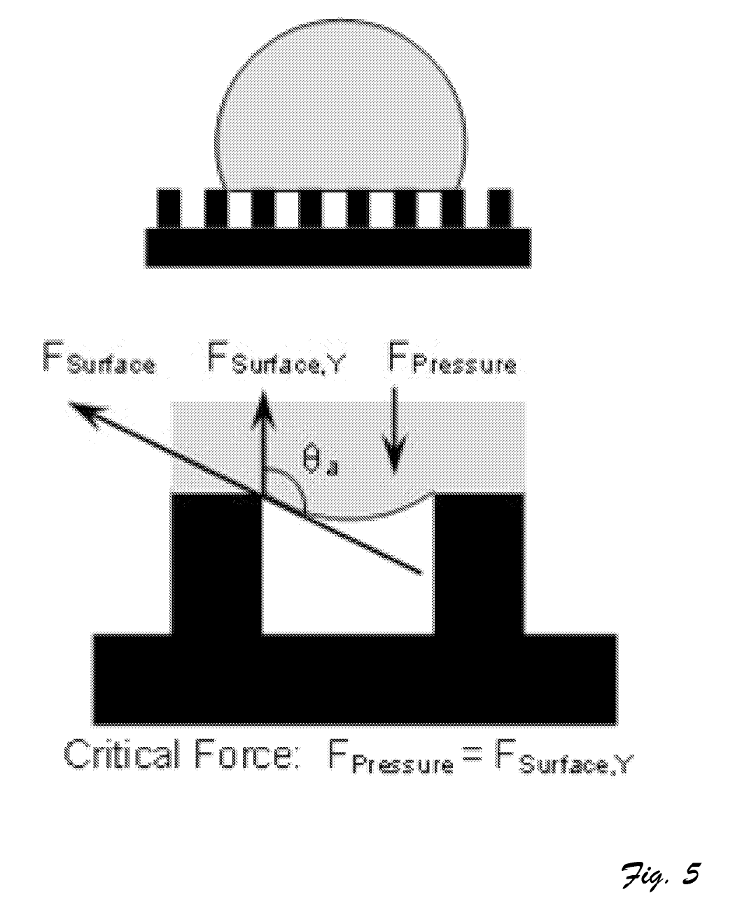

In general, smaller structures resist higher pressure than larger structures. We analyzed the competing forces between surface tension and pressure as FIG. 5 shows. Previous work has shown that the critical pressure at which liquid penetrates microstructures can be predicted with

$${P}_{c} = \frac{- ϕγcos {θ}_{a}}{λ ( 1 - ϕ )} \qquad ( 5 )$$

where φ is area fraction of the tops of the microstructures, γ is surface tension of the liquid, θₐ is advancing contact angle, and λ is the ratio of the microstructure top area/perimeter. Pressure resistance is increased by high area fraction φ, low top area/perimeter ratio λ, and high advancing contact angle θₐ. Holding spacing and lattice type constant, top area/perimeter ratio λ decreases with decreasing structure size. Therefore, smaller structures maintain the Cassie-Baxter state under higher pressure than do larger structures.

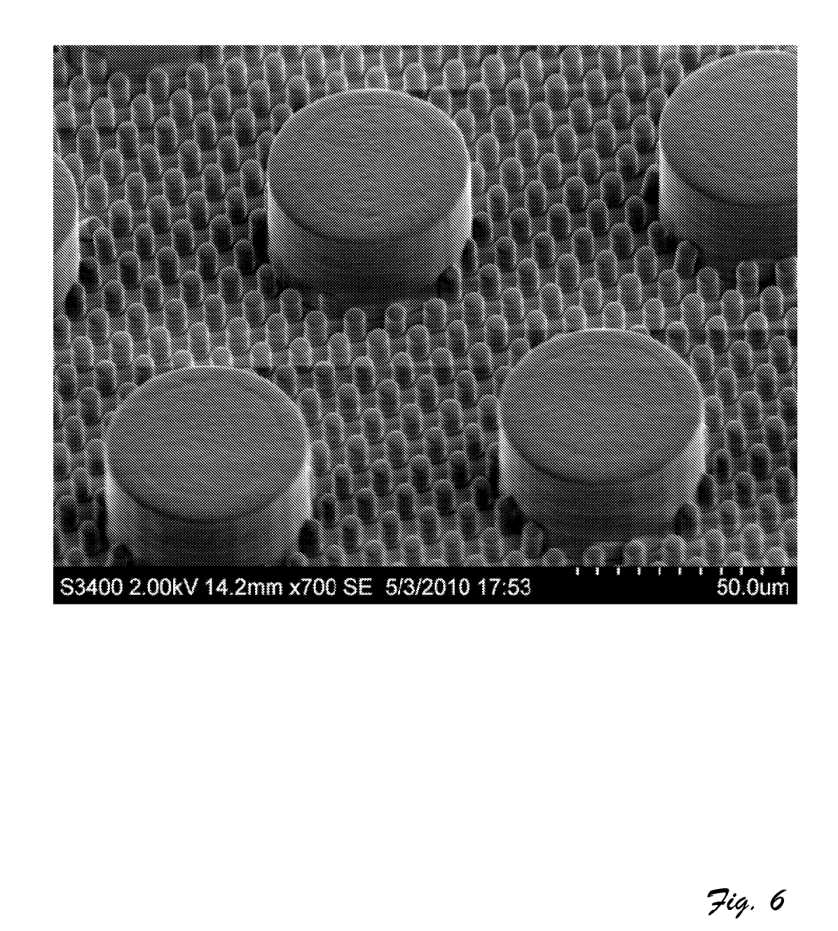

FIG. 6 shows the fabricated multi-scale structures. The larger structures are 50 μm diameter×50 μm spacing and 35 μm tall. The larger structures protect the smaller superhydrophobic structures which are 5 μm diameter×5 μm spacing×8 μm tall. In one embodiment, one set of microfeatures included in the microstructure can cause the surface carrying the set of microfeatures to exhibit physical properties that include reduced friction, increased friction, increased heat transference, decreased condensation, increased condensation, liquid repellency, increased absorbance, increased capacitance, increase surface fluid storage, reduced boiling points of a substance in contact with the surface, increased boiling points of a substance in contact with the surface, reduced fluid drag, increased fluid drag, reduced sliding force, increased sliding force, reduced sliding force with applied lubrication, hydrophobic properties, hydrophilic properties, electrical properties, self-cleaning, reduction in hydrodynamic drag, reduction in aerodynamic drag, optical effects, prismatic effects, direction color effects, tactile effects, and any combination of these. In one embodiment, a second set of microfeatures can be included in the microstructure and can result in physical properties taken from the same group as that of the first set of microfeatures. In one embodiment, the second set of microfeatures is load bearing.

The microfeatures can include various shapes including holes, pillars, steps, ridges, curved regions, raised regions, recessed regions, cones, columns, square columns, rectangular columns, pyramids, asymmetrical shapes and any combination of these. The microfeatures can also have cross sections that are circles, ellipses, triangles, squares, rectangles, polygons, stars, hexagons, letters, numbers, mathematical symbols, asymmetrical shapes, and any combination of these. The cross section of the first set of microfeatures can be different than that of the second set of microfeatures.

When the microstructure includes two or more sets of microfeatures, the distribution can be bimodal or multimodal. Each microfeature of a set of microfeatures can have approximately the same dimensions resulting in a uniform pattern of microfeatures. For example, the smaller the microfeatures shown in FIG. 6 are uniform throughout their pattern.

In one embodiment, the first set of microfeatures can be adjacent to the second set of microfeatures. In one embodiment, a preselected pattern of microfeatures includes a region of microfeatures having multiple cross sectional shapes. In one embodiment, a preselected pattern of microfeatures refers to two or more arrays of microfeatures of two or more cross-sectional shapes. In a specific embodiment, the two or more arrays can be positioned side by side; that is, where the two arrays do not overlap. In another specific embodiment, the two or more arrays are positioned to overlap. Microfeatures having the two or more distinctive pattern areas result. In one embodiment, the microfeatures of the second set of microfeatures replace a portion of the microfeatures of the first set of microfeatures.

Microfeatures can be manufactured through the process of stamping, rolling, forging, casting, molding, etching, milling, drilling, plating, electroforming, power processing, electrical discharge machining, and any combination of these.

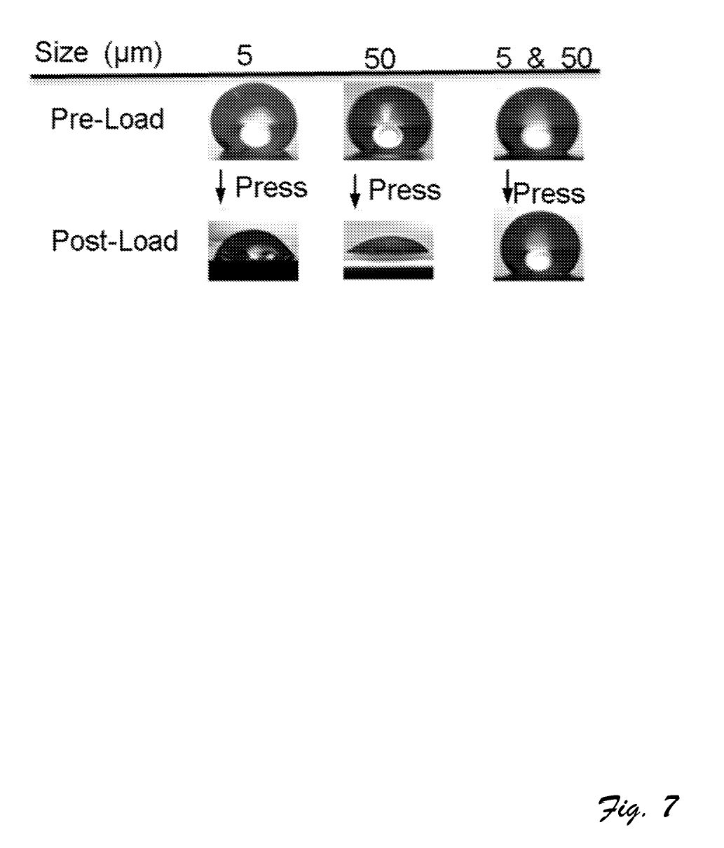

FIG. 7 illustrates the pressure resilience results. To test the pressure resilience of the structures shown in FIG. 6, we deposited 10 μl water droplet on the micropillars and measured contact angle and slide angle. We refer to this first set of measurements as Pre-Load measurements. A polycarbonate sheet then applied 1 psi pressure load for 10 seconds to the 10 μl drop resting on the surface. Once the polycarbonate sheet was removed, another 10 μl droplet was placed on the same spot as the pressed droplet, and contact angle and slide angle were measured. We refer to this second set of measurements as Post-Load measurements. FIG. 7 shows that while silicone with only 5 μm structures or only 50 μm structures suffered a large decrease in contact angle due to contact line pinning, the silicone with a combination of microstructures sizes experienced negligible changes in contact angle.

The smaller structures provide superhydrophobic performance while the larger structures carry the load that interacts with the surface, protecting the smaller structures. 10 μl droplets rested on three different silicone micropillar surfaces: homogeneous 5 μm diameter micropillars, homogeneous 50 μm diameter micropillars, and the heterogeneous combination of 5 and 50 μm diameter micropillars shown in FIG. 6. After experiencing surface load, the homogeneous structures experienced contact line pinning and decreased contact angle while the heterogeneous micropillars resisted contact line pinning.

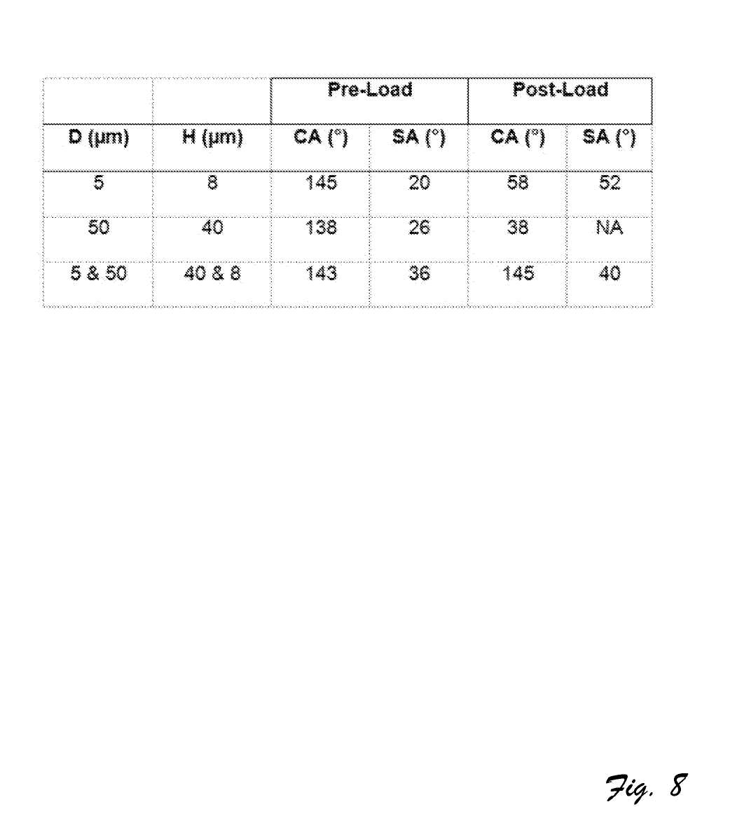

FIG. 8 shows that while silicone with only 5 μm structures or only 50 μm structures suffered a large decrease in contact angle and a large increase in slide angle, the silicone with a combination of microstructures sizes experienced negligible changes in contact angle and slide angle. FIG. 8 shows contact angle and slide angle before and after applied load on droplets resting on microstructured silicone. The homogeneous microstructures experienced a significant increase in slide angle and decrease in contact angle while the heterogeneous 5 & 50 μm microstructures experienced negligible changes in contact angle and slide angle.

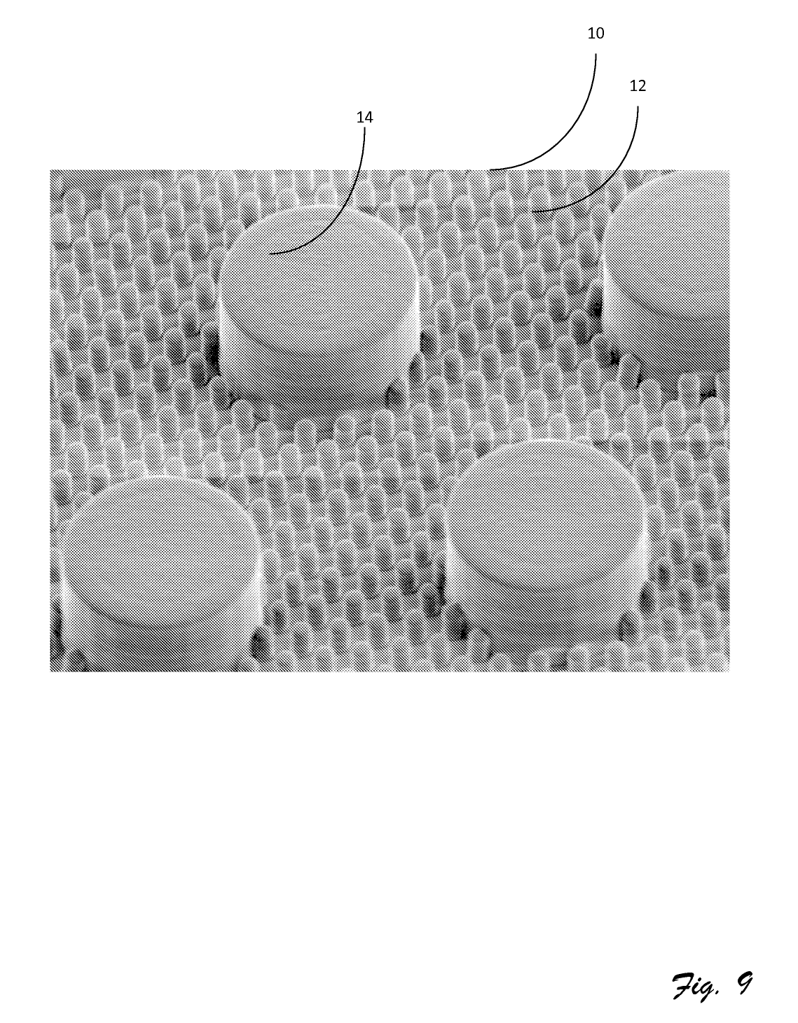

Referring to FIG. 9, the surface of a part having a microstructure is shown as 10. A first set of microfeatures 12 is shown on the surface. A second set of microfeatures 14 is shown being interdispersed within the first set of microfeatures. The material comprising the first or second set of microfeatures can be selected from the group consisting of: thermoplastic polymers, thermosetting polymers, metals, ceramics, and glass.

The first and second set of microfeatures can be combined by a method selected from the group of interspersing the microfeatures of one set with those of another set; replacing some members of one set with members of another set, and stacking microstructures from one set on top of microstructures of another set.

In one embodiment, the first set of microfeatures are generally columns having a height over the range of 5 μm to 10 μm with a diameter over the range of 3 μm 7 μm with spacing over the range of 3 μm to 7 μm.

In one embodiment, the second set of microfeatures are generally a column having a height over the range of 10 nm to 200 μm, a width over the range of 10 nm to 200 μm, lengths over the range of 10 nm to 200 μm and spacing over the range of 10 nm to 200 μm.

In one embodiment, the height of the first set of microfeatures has a height of less than 10 nm and the height of said second set of microfeatures is greater than 200 μm. In one embodiment, at least one set of microfeatures includes dimensions over the range of 10 nm to 200 μm. In one embodiment, the microfeatures are comprised of varying dimensions selected from the group of: height, width, spacing, and any combination of these. Further, the orientation of one pattern to another, and the ordered array of the features can vary across the surface.

The first and second set of microfeatures can include holes, pillars, steps, ridges, curved regions, recessed regions, raised regions, and any combination of these employing any cross-sectional shape including circles, ellipses, triangles, squares, rectangles, polygons, stars, hexagons, letters, numbers, mathematical symbols, asymmetrical shapes, and any combination of these. The microfeatures of each of the sets can form a pattern.

In one embodiment, the first set of microfeatures provides advantageous properties selected form the group of: load carrying; protection of underlying surface features; hydrophobicity; hydrophilicity; self-cleaning properties; hydro and/or aerodynamic drag coefficients; optical effects such as prismatic effects, specific colors, reflection, directional dependent color changes, and gloss; tactile effects; grip; electrical characteristic control such as capacitance level; and surface frictional properties.

In one embodiment, the first set of microfeatures provides the function superhydrophobicity and the second set of microfeatures provides the function of load bearing. The first and second set of microfeatures can be carried by a curved surface.

In one embodiment, the set of first or second microfeatures includes one or more macro scale features where the macro scale features can be selected from the group comprising of: channels, grooves, bumps, ridges, recessed regions, raised regions, and any combination of these. The macro scale features can have dimensions selected over the range of 1 mm to 1 m.

In one embodiment, the first or second set of microfeatures comprises a lithographically patterned flexible polymer.

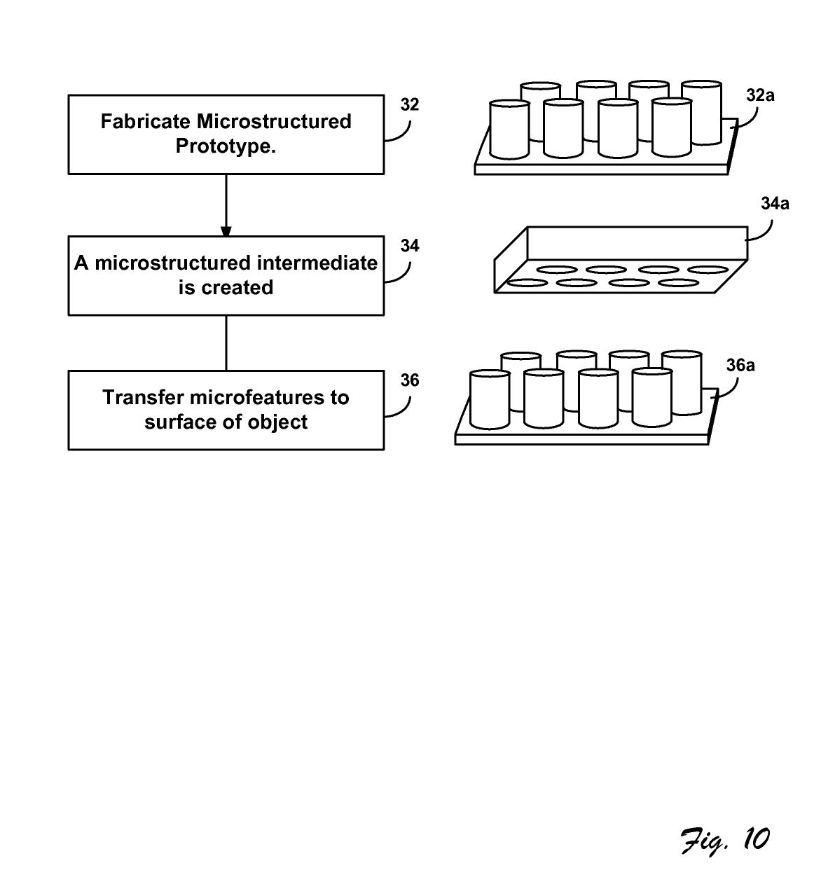

Referring to FIG. 10, one embodiment of the present invention is illustrated. A particular pattern of one or more microfeatures is selected from a set of predefined microstructure patterns. A microstructured prototype 32a is fabricated at 32 using the selected microfeatures so that the microstructured prototype has the microfeature or set of microfeatures on its surface. A microstructured intermediate 34a is created at step 34. The microstructured intermediate can be made from thermoplastic, thermoplastic polymer, thermoset, or rubber. The microfeatures of the microstructured intermediate is used to transfer the microstructure onto the surface of an object 36a at step 36.

In one embodiment, the microstructured prototype takes the form of a silicon wafer or a polymer and can be created by molding, casting and the like. The silicon wafer is patterned with a preselected set of microstructures. Using casting, the pattern is then transferred from the silicon wafer so that the microstructure pattern is formed into silicone rubber. The silicon rubber is then provided to mold the microstructures to an engineering polymer or metal roller surface material. This engineering polymer material transfers the microstructures to material entering the roller press, such as aluminum foil. Accordingly, this forms the microstructures on the object's surface, such as a thin metal foil, through cold-forge molding.

The predefined patterns of microstructures can be made using a method selected from the group consisting of: photolithography, laser ablation, laser cutting, printing, engraving, machining, replication molding, electron-beam lithography, nano-imprint lithography, and any combination of these.

In one embodiment, fabricating the microstructured prototype includes the steps of: providing a semiconductor wafer, patterning the semiconductor wafer with the preselected pattern of microfeatures, molding an uncured flexible polymer to the patterned semiconductor wafer, curing the polymer, thereby forming a microstructured flexible polymer having the preselected pattern of microfeatures, removing the microstructured flexible polymer from said patterned semiconductor wafer and deforming at least a portion of said microstructured flexible polymer so as to conform the microstructured flexible polymer to at least a portion of the surface of the one or more macro scale features of said microstructured prototype.

While a preferred embodiment of the invention has been described using specific terms, such description is for illustrative purposes only, and it is to be understood that changes and variations may be made without departing from the spirit or scope of the following claims.

What is claimed is:

1. A microstructure disposed on a surface carried by an object comprising:
a first set of microfeatures carried by the object wherein said first set of microfeatures cause the surface of the object to exhibit properties selected from the group of: reduced friction, increased friction, increased heat transference, decreased condensation, increased condensation, liquid repellency, increased absorbance, increased capacitance, increased surface fluid storage, reduced boiling points of a substance in contact with the surface, increased boiling points of a substance in contact with the surface, reduced fluid drag, increased fluid drag, reduced sliding force, increased sliding force, reduced sliding force with applied lubrication, hydrophobic properties, hydrophilic properties, electrical properties, self-cleaning, reduction in hydrodynamic drag, reduction in aerodynamic drag, optical effects, prismatic effects, direction color effects, tactile effects, and any combination of these; and,
a second set of microfeatures carried by said surface wherein said second set of microfeatures is load bearing.

2. The microstructure of claim 1 wherein said second set of microfeatures include an apex higher than the highest peak of said first set of microfeatures.

3. The microstructure of claim 1 wherein said first set of microfeatures is selected from the group consisting of: holes, pillars, steps, ridges, curved regions, raised regions, recessed regions, cones, columns, square columns, rectangular columns, pyramids, asymmetrical shapes, and any combination of these.

4. The microstructure of claim 1 wherein portion of said first set of microstructures has a cross section selected from the group consisting of: circles, ellipses, triangles, squares, rectangles, polygons, stars, hexagons, letters, numbers, mathematical symbols, asymmetrical shapes, and any combination of these.

5. The microstructure of claim 1 wherein portion of said second set of microstructures has a cross section selected from the group consisting of: circles, ellipses, triangles, squares, rectangles, polygons, stars, hexagons, alpha-numeric characters, mathematical symbols, asymmetrical shapes, and any combination of these.

6. The microstructure of claim 1 wherein said first set of microfeatures has a bimodal distribution of its respective microfeatures' dimensions.

7. The microstructure of claim 1 wherein each microfeature of said first set of microfeatures has approximately the same dimensions and each microfeature of said second set of microfeatures has approximately the same dimensions.

8. The microstructure of claim 1 wherein said first set of microfeatures has dimensions between 10 nm and 1 μm and said second set of microfeatures has dimensions between 1 μm and 100 μm.

9. The microstructure of claim 1 wherein the height:width ratio of said first set of microfeatures is between 1:20 and 7:1.

10. The microstructure of claim 1 where said first set of microfeatures have dimensions between 1 μm and 500 μm and said second set of microfeatures has dimensions 100 μm and larger.

11. The microstructure of claim 1 wherein the surface is curved.

12. The microstructure of claim 1 wherein said spacing between the individual microfeatures of said first set of microfeatures is variable.

13. The microstructure of claim 1 wherein said spacing between the individual microfeatures of said second set of microfeatures is variable.

14. The microstructure of claim 1 wherein a cross section of a microfeature of said first set of microfeatures is different than a cross section of a microfeature of said second set of microfeatures.

15. The microstructure of claim 1 wherein said second set of microfeatures is interposed in said first set of microfeatures.

16. The microstructure of claim 1 wherein said second set of microfeatures is adjacent to said first set of microfeatures without overlapping.

17. The microstructure of claim 1 wherein said first set of microfeatures is manufactured by a method selected from a group consisting of: stamping, rolling, forging, casting, molding, etching, milling, drilling, plating, electroforming, power processing, electrical discharge machining and any combination of these.

18. The microstructure of claim 17 wherein said first set of microfeatures is manufactured by a different method than that of said second set of microfeatures.

19. The microstructure of claim 1 wherein said first set of microfeatures and said second set of microfeatures are integrated into the surface.

20. A method for manufacturing a microstructured manufacturing object comprising the steps of: fabricating a microstructured prototype having a first set of microfeatures that cause the surface of the object to have properties selected from a group of: reduced friction, increased friction, increased heat transference, decreased condensation, increased condensation, liquid repellency, increased absorbance, increased capacitance, increase surface fluid storage, reduced boiling points of a substance in contact with the surface, increased boiling points of a substance in contact with the surface, reduced fluid drag, increased fluid drag, reduced sliding force, increased sliding force, reduced sliding force with applied lubrication, hydrophobic properties, hydrophilic properties, electrical properties, self-cleaning, reduction in hydrodynamic drag, reduction in aerodynamic drag, optical effects, prismatic effects, direction color effects, tactile effects, and any combination of these, and, a second stet of microfeatures carried by said surface wherein said second set of microfeatures is load bearing;
creating a microstructured intermediate from said microstructured prototype so that the surface of said intermediate is a negative of said surface of said microstructured prototype; and,
creating the microstructured manufacturing object from said microstructured intermediate.

21. The method of claim 20 wherein said microstructured intermediate is formed from a material selected from a group consisting of: thermoplastic, thermoplastic polymer and rubber.

22. The method of claim 20 wherein fabricating said microstructured prototype includes fabricating said first set of microfeatures to have dimensions between 10 nm and 1 μm and said second set of microfeatures to have dimensions between 1 μm and 100 μm.

23. The method of claim 20 wherein fabricating said microstructured prototype includes fabricating said microstructured prototype so that a height:width ratio of said first set of microfeatures is between 1:20 and 7:1.

24. The method of claim 20 wherein fabricating said microstructured prototype includes fabricating said first set of microfeatures to have dimensions between 10 nm and 100 μm and said second set of microfeatures to have dimensions of 100 μm and larger.

25. The method of claim 20 wherein said step of creating a microstructured intermediate include creating said microstructured intermediate that is a cylindrical engineered polymer used for roll milling.

26. The method of claim 20 wherein said microstructured intermediate is created from a material selected from a group consisting of: polyphenyl sulfone, self-reinforced polyphenylene, Acrylonitrile butadiene styrene (ABS), Polycarbonates (PC), Polyamides (PA), Polybutylene terephthalate (PBT), Polyethylene terephthalate (PET), Polyphenylene oxide (PPO), Polysulphone (PSU), Polyetherketone (PEK), Polyetheretherketone (PEEK), Polyimides, and Polyphenylene sulfide (PPS).

27. A microstructure disposed on a surface carried by an object comprising:
a first set of microfeatures carried by the object wherein said first set of microfeatures causes the surface of the object to exhibit physical properties differing from physical properties exhibited by a non-microstructured surface; and,
a second set of microfeatures carried by said surface wherein said second set of microfeatures causes the surface of the object to exhibit physical properties differing from physical properties exhibited by the non-microstructured surface and by said first set of microfeatures.

28. The microstructure of claim 27 wherein said second set of microfeatures is load bearing.

29. The microstructure of claim 27 wherein said second set of microfeatures include an apex higher than the highest peak of said first set of microfeatures.

30. The microstructure of claim 27 wherein said first set of microfeatures and said second set of microfeatures have a bimodal distribution across the surface.

31. The microstructure of claim 27 wherein said first set of microfeatures has dimensions between 10 nm and 1 μm and said second set of microfeatures has dimensions between 1 μm and 500 μm.

32. The microstructure of claim 27 wherein said first set of microfeatures has dimensions at least an order of magnitude smaller than said second set of microfeatures.

33. The microstructure of claim 32 wherein said first set microfeatures has dimensions between 1 μm and 500 nm.

34. The microstructure of claim 33 wherein said first set microfeatures has dimensions between 1 μm and 100 nm.

35. The microstructure of claim 27 wherein a height:width ratio of said first set of microfeatures is between 1:20 and 7:1.

36. The microstructure of claim 27 wherein a height:width ratio of said second set of microfeatures is between 1:20 and 7:1.

37. The microstructure of claim 27 where said first set of microfeatures has dimensions between 10 nm and 100 μm and said second set of microfeatures has dimensions 100 μm and larger.

38. The microstructure of claim 27 wherein said microstructure is manufactured by a method selected from a group consisting of: stamping, rolling, forging, casting, molding, etching, milling, drilling, plating, electroforming, electrical discharge machining, and any combination of these.

39. The microstructure of claim 37 wherein said first set of microfeatures is manufactured by a different method than that of said second set of microfeatures.

40. The microstructure of claim 27 wherein said second set of microfeatures is stacked on top of said first set of microfeatures.

41. The microstructure of claim 27 wherein said second set of microfeatures replaces a portion of said first set of microfeatures.

42. The microstructure of claim 27 wherein:
said first set of microfeatures has a cross section selected from the group comprising: circles, ellipses, triangles, squares, rectangles, polygons, stars, hexagons, asymmetrical shapes, alpha-numeric characters, mathematical symbols, asymmetrical shapes, and any combination of these; and,
a second set of microfeatures carried by said surface wherein said second set of microfeatures has a cross section selected from the group comprising: circles, ellipses, triangles, squares, rectangles, polygons, stars, hexagons, asymmetrical shapes, alpha-numeric characters, mathematical symbols, asymmetrical shapes, and any combination of these and wherein said cross section of said second set of microfeatures is distinct from said first set of microfeatures.

43. The microstructure of claim 1 where said first set of microfeatures have dimensions between 1 μm and 500 μm and said second set of microfeatures has dimensions 10 μm and larger.
